(19) United States
(12) Patent Application Publication
(10) Pub. No.: US 2002/0066400 A1
(43) Pub. Date: Jun. 6, 2002

(54) Personnel location control system with informational message presentation

(76) Inventors: Dan Pharo, Valencia, CA (US); Alex J. Humbree, Salt Lake City, UT (US)

Correspondence Address: Robert J. Schaap, 21241 Ventura Blvd., Ste. 188, Woodland Hills, CA, 91364, US

(21) Appl. No.: 10/056,714

(22) Filed: Oct. 24, 2001

Related U.S. Application Data
(63) Continuation of application No. 09/307,104, filed on May 6, 1999, now abandoned.
(63) Continuation-in-part of application No. 08/741,619, filed on Oct. 30, 1996, now abandoned.
(60) Provisional application No. 60/084,591, filed on May 7, 1998.

(51) Int. Cl. G09F 9/00; G08B 1/00

(52) U.S. Cl. 116/278; 116/200

(57) ABSTRACT

A personnel placement and location control system for controlling movement of one or more individuals to a particular designation. In a preferred embodiment, the location control system functions as a personnel guidance and location control system for controlling and guiding one or more individuals in a selected path to a waiting point and then to an activity in advance of that waiting point or otherwise to a particular destination. The system relies upon a plurality of indicators or markers which may be secured to a floor or ground surface or which may be formed on or secured to floor coverings on that floor surface and which define guide paths for the one or more individuals. Various floor covering segments can be also secured in desired combinations to achieve a desired guide path. In one embodiment, a pocket forming section is provided in the floor covering for receiving a substrate containing informational material. This material may be in the nature of instructional material or otherwise promotional or advertising material. The information receiving substrate section is capable of receiving individual substrates bearing such information in a manner in which they can be readily introduced or removed from the floor covering material. Moreover, these information bearing substrates can be a series of advertisements in a pathway or, otherwise, they can identify places or locations for one or more individuals to stand for either waiting to advance to an activity or otherwise to stand at that activity.

### BACKGROUND OF THE INVENTION

1. Field of the Invention

This invention relates to certain new and useful improvements in personnel waiting guidance, placement and location control systems for guiding individuals in a controlled manner and also for providing floor located informational material to one or more individuals while in that pathway or otherwise at a particular place for an activity.

2. Brief Description of the Related Art

Personnel guidance and location control systems have been used in a variety of activities for controlling a path of movement for one or more individuals to a particular activity. These guidance and location control systems usually rely upon a group of poles with guide ropes to guide a group of individuals into a standing line, where each of the individuals in that line advance progressively toward a particular activity as, for example, a teller in a bank or otherwise to a ticket counter in an airline terminal, etc.

There have also been personnel guidance and location control systems which rely upon painted lines on a floor or ground surface to define a guidance path to a particular activity.

Each of these commercially available guidance and location control systems suffer from a number of drawbacks which limit their effectiveness. In the case of the poles and flexible ropes or cables, the individual components are loosely mounted on a floor surface and are subject to vandalism and theft. Secondly, they can be readily moved by the individuals for either enhancing the position of such individuals in a line of waiting individuals, or because of sheer nuisance purposes. Moreover, when these temporary personnel guidance and location control systems are located in an exterior environment, they must be periodically removed and stored to prevent further theft or vandalism as, for example, when an activity has closed.

Painted markers suffer a number of problems, such as the erosion and the wearing away, as previously described. Moreover, there are many ground surfaces in which it is virtually impossible to paint a straight line or other guide forming line. For this purpose, tapes have been applied to ground surfaces in order to produce a guide path. However, the tapes rub off or, again, after a period of time, loose their adhesiveness for securement to the ground surface.

In my aforesaid co-pending patent applications, there are set forth various guidance and location control systems which meet and, at least, partially overcome some of the previously described problems. However, these presently available personnel guidance, placement and location control systems do not provide any informational material at a floor level to the one or more individuals who may be walking or standing in that guide path. It has been recognized that while waiting in a line of individuals or in a guide path to reach a particular activity, the people standing are particularly amenable to reading or observing material which will at least occupy a portion of the time while waiting to reach or achieve a particular activity. There has been no commercially available or even proposed system which provides for the interchangeability of informational bearing substrates in a floor covering and which allows for an occupant in that pathway or at a particular location to observe that material. Moreover, it is important to constantly change that material, as, for example, from day to day, so that the user of the guidance and location control system will not become bored by a single message which seemingly never changes.

There have been individual placemats or, for that matter, floor coverings which bear information as, for example, placemats at soft drink dispensers identifying the location for obtaining a soft drink or otherwise containing promotional or advertising material. As a simple example, a particular placemat or floor covering in front of a drink dispenser could read “Drink Crush Cola”. However, in all such cases, the information bearing material is permanently provided and, if there was any need or desire to change the message or, for that matter, the graphic material surrounding the message, it would be necessary to use or install a new placemat. In like manner, carpet sections have been located at the entrance to various institutions as, for example, a carpet section bearing a hotel's name at the entrance to that hotel. However, and here again, the information in that carpet section is permanently incorporated in the mat and cannot be changed.

It would be desirable to provide a personnel location control system which not only provides cuing information to the individual for instructing placement of the individual at a particular location, but to also provide readily changeable informational bearing material on the floor surface. It would also be desirable to provide a personnel location control system which also functions as a guidance system for guiding a group of individuals in a selected pathway and also providing readily changeable informational bearing material thereon.

### OBJECTS OF THE INVENTION

It is, therefore, one of the primary objects of the present invention to provide a personnel location control system in which a ground covering material can be removably located on a ground surface and which may define either a guidance pathway or a location for a particular activity, or both.

It is another object of the present invention to provide a personnel guidance, placement and location control system of the type stated in which guide path forming elements can be altered for easily and quickly altering a guide path.

It is a further object of the present invention to provide a personnel guidance, placement and location control system of the type stated in which individual floor covering segments can be substituted for one another in order to form a desired guide path or otherwise to form a particular location for standing at a certain activity.

It is an additional object of the present invention to provide a personnel guidance, placement and location control system of the type stated in which a plurality of ground covering segments may be used and connected together in various desired patterns.

It is also an object of the present invention to provide a personnel guidance, placement and location control system of the type stated in which informational bearing material at a floor level on floor covering material can be easily and readily changed without the necessity of materially changing the floor covering material.

It is still another object of the present invention to provide a personnel location control system of the type stated in which instructional material can be imparted to one or more users in a guide path or otherwise at a particular activity, or otherwise in which promotional and advertising material may be presented and which is capable of being rapidly and readily changed without the necessity of removing an entire floor covering material.

It is still a further objection of the present invention to provide a method of altering information bearing materials on a floor covering both rapidly and inexpensively and in such manner that the information is either effectively used or highly pleasing to the observer.

With the above and other objects in view, our invention resides in the novel features of form, construction, arrangement and combination of parts and components presently described and pointed out in the claims.

### BRIEF SUMMARY OF THE INVENTION

A personnel location control system for controlling movement of pedestrian individuals using floor covering materials, and for also providing readily changeable information on said floor covering materials. The invention also relates to a personnel guidance and location control system for forming a guide path in which to move a group of pedestrian individuals in an orderly and controlled fashion to a particular activity or destination.

In one embodiment of the invention, the location control system may rely upon a single floor covering substrate to identify a particular location in which an activity may occur. In another embodiment of the invention, the location control system may rely upon a plurality of floor covering segments which are arranged in a particular desired configuration to define a path of movement for a group of individuals. In this way, the location control system becomes a personnel guidance and location control system.

The location control system of the present invention may also rely upon a plurality of markers which define a guide pathway. These markers may be small, discrete markers or elements and they may also be used in conjunction with any elongate or similar marker which identifies a head of a line position. In this way, the one or more individuals will be guided in a particular guide path to a front end of head of a line position and which then leads to a particular activity.

While the present invention may be operable with a location control system or otherwise a personnel guidance and location control system, this invention also provides an informational bearing material at a floor level for providing instructional material to a user. This informational material preferably is provided on or in one or more of the ground covering substrates. Thus, the informational material may be presented at a particular standing location or in a guided pathway. It may also otherwise present marketing or promotional material to a user in that standing location or in a particular guidance path. In this particular case, the present invention relies upon information bearing substrates which can be readily interchanged and replaced without the necessity of substantially altering or removing a floor covering material. Various means for achieving this changeability of information bearing substrates is hereinafter described.

The formation of guide paths for one or more individuals to reach a head of a line position is described in the aforesaid co-pending U.S. patent application Ser. No. 08/741,619, dated Oct. 30, 1996, and also in a co-pending continuation-in-part U.S. patent application Ser. No. ______, filed contemporaneously herewith, for Personnel Guidance and Location Control System. Accordingly, the actual formation of a guidance pathway is not described in detail herein, except to the extent necessary for its applicability in the present invention. Nevertheless, to the extent that material from that aforesaid co-pending patent applications are not physically incorporated herein, such material is incorporated herein by reference.

In one embodiment of the invention the guidance and location control system comprises an elongate element and a plurality of small discrete elements which are capable of being secured to a carpet or other floor material in fixed locations where the small discrete elements are fixed and relative to the elongate element in a desired arrangement to define a desired guide path. This arrangement would typically define a pathway for controlling the movement of a group of people to an end of the line designation therefor.

The guidance location and control system in that aforesaid co-pending patent application is highly effective and is uniquely capable of being arranged in a variety of patterns. Thus, there is, in effect, no limitation to the individual patterns which can be achieved. In accordance with this system, the pattern which is desired, including the pathway for controlling the movement of a group of people, as well as the end of line position, can all be pre-formed on this ground cover substrate, which is then disposed on or secured to a ground surface.

The discrete elements and the elongate element can all be secured, for example, to a piece of carpet material which is laid over a ground surface. This carpet material, in one embodiment, could have the discrete elements and the elongate element secured by means of fasteners on the underside of each of these elements. Nevertheless, when secured to the ground cover, such as the carpet in a desired location, installation is very quick and simple, in that the ground cover substrate is then secured to a ground surface.

In another embodiment of the invention, the discrete elements and the elongate element are integrally formed into the carpet material. During the weaving process, the carpet itself may be formed of a e.g. gray colored material. However, the weaving apparatus would be pre-programmed to incorporate white areas representing the white discrete elements and elongate element. Thus, when the carpet is woven, these discrete elements and the elongate element, with the latter representing the end of the line position, would all be integral in a carpet material substrate. When the ground cover is a sheet of vinyl, the vinyl can be preprinted with the desired pattern.

In another embodiment of the invention, holes could be formed in a carpet sheet representing a ground cover substrate and plugs of different colored carpet material would be inserted in those holes. Thus, an elongate hole having the shape of the elongate element would receive an elongate element formed of the same material but of a different color than the carpet substrate. The same holds true for the small discrete elements.

In yet another embodiment of the invention, the ground cover substrates can be provided as modular substrates. In accordance with this embodiment of the invention, a plurality of ground cover substrates are provided and with certain of the ground cover substrates having different guidance patterns of discrete elements than others of the ground cover substrates. Thus, one of the substrates will have an elongate element formed thereon as a head of a line position and few of the discrete elements thereon to represent the beginning of the pathway for a group of individuals. Another ground cover substrate could have the individual discrete elements formed thereon in a linear row. Still another ground cover substrate could have the small discrete elements formed thereon in a arcuate pattern to represent a turn in the pathway. Any of a number of patterns could be pre-formed on other ground segments.

When a user of the system desires to set up its own guidance location and control system, the user would select the desired patterns, such that the user could assemble the ground cover substrates in a desired arrangement to obtain that pathway desired by the user.

The informational material which is incorporated in the ground covering substrates may adopt a variety of forms. Thus, for example, the informational material may be advertising or promotional material. With respect to this material, it is important to frequently change this material, so as to avoid boredom to those pedestrians who will frequently use a particular locational control system. In addition, the informational material may adopt a form of information to users in various institutions about which activities are occurring in a particular line. As an example, in a post office, the informational message in the substrate can be changed periodically so as to represent for one day, an express mail line, and on another day, a purchase postage only line, etc. It is not necessary to change the substrate, but merely the informational material carried thereby.

It is also possible to use a single individual substrate which does not identify a pathway. With the informational substrate, this is highly effective for promoting particular articles. For example, a mat may be located at a drink dispenser, and on one day, the mat may contain a message about a particular manufacturer's soft drink, and on another day, it may contain another message about another manufacturer's soft drink.

The informational display may be inserted into a pocket formed in a substrate, having a closable, transparent upper flap. Moreover, the substrate may be provided with a depression therein in order to receive the informational bearing material, and which is again covered by a transparent outer sheet. Further, foam material can be incorporated in the region of the informational bearing substrate so as to highlight the particular message contained thereon. In addition, it is possible to provide electrical lights to further enhance an informational bearing material.

This invention has many other advantages and purposes which will become more fully apparent from the following detailed description and the accompanying drawings which illustrate one of the preferred embodiments of the personnel waiting control system. However, it is to be understood that this following detailed description and the accompanying drawings are set forth only for purposes of illustrating and describing the general principles of the invention and are not to be taken in a limiting sense.

### BRIEF DESCRIPTION OF THE DRAWINGS

Having thus described the invention in general terms, reference will now be made to the accompanying drawings in which:

FIG. 1 is a top plan view showing one embodiment of the personnel waiting guidance and control system constructed in accordance with and embodying the present invention;

FIG. 2 is a fragmentary side elevational view, partially in section, of the elongate element mounted on a substrate and forming part of the control system of the present invention;

FIG. 3 is a side elevational view of one form of discrete small guide path defining element forming part of the personnel control system of the present invention;

FIG. 4 is a top plan view of the one form of the elongate end of the line element forming part of the personnel system of the present invention;

FIG. 5 is a fragmentary side elevational view of one form of ground cover substrate forming part of a personnel guidance and location control system of the present invention;

FIG. 6 is a top plan view of one form of ground cover substrate forming part of the personnel guidance and location control system of the present invention;

FIG. 7 is a fragmentary sectional view showing another embodiment of a ground cover substrate forming part of the personnel control system of the present invention;

FIG. 8 is a composite of individual ground cover substrates in modular form which can be arranged in a desired combination to form a guidance and location control system in accordance with the present invention;

FIG. 9 is a side elevational view showing an arrangement of ground cover substrates connected together;

FIG. 10 is a fragmentary side elevational view showing one means for securing ground cover substrates to a carpeted ground surface;

FIG. 11 is a fragmentary side elevational view showing another means for securing ground cover substrates to a hard ground surface;

FIG. 12 is a fragmentary plan view of another modified form of ground cover substrates, which can be releasably connected together;

FIG. 13 is a fragmentary plan view similar to FIG. 12 and showing still other forms of ground cover substrates which can be connected together;

FIG. 14 is a plan view showing another modified form of guidance and message presenting system in which components thereof were not necessarily connected together;

FIG. 15 is a fragmentary plan view showing still a further modified form of location control system in accordance with the present invention and which uses position indicating electric lights;

FIG. 16 is a fragmentary vertical sectional view showing one form of presenting a message in a ground cover substrate;

FIG. 17 is a fragmentary vertical sectional view similar to FIG. 16, and showing another means for presenting a message in a ground cover substrate;

FIG. 18 is a fragmentary plan view showing a single position location control system providing an informational message in accordance with the present invention;

FIG. 19 is a top plan view of a modified form of personnel control system also presenting changeable messages thereon;

FIG. 20 is a fragmentary vertical sectional view of still a further modified form of presenting messages in a ground cover substrate;

FIG. 21 is a fragmentary vertical sectional view showing a modified form of providing an informational message to an upper surface of a ground covering substrate;

FIG. 22 is a fragmentary vertical sectional view, similar to FIG. 21, and showing a slightly modified form of presenting the informational messages on the upper surface of a substrate;

FIG. 23 is an exploded fragmentary vertical sectional view showing components forming part of a modified system for presenting an informational message in a ground covering substrate; and

FIG. 24 is a fragmentary vertical sectional view, similar to FIG. 23, and showing the components of FIG. 23 in an assembled form.

### DETAILED DESCRIPTION OF A PREFERRED EMBODIMENT

Referring now in more detail and by reference characters to the drawings which illustrate a preferred embodiment of the present invention, S designates a personnel guidance and control system comprised primarily of a ground cover substrate 20, as hereinafter described in more detail. Mounted in the substrate 20 is an elongate element or member and referred to as a “head of the line” member 22 and a group of small discrete path defining members 24.

The elongate element 22 and the path defining discrete elements 24 are preferably located on the ground cover substrate 20 in a particular arrangement to define a path of movement of a group of individuals in a waiting area so that each of the individuals may then advance to a selected activity.

In accordance with the present invention, and merely for the purposes of illustrating the present invention, the personnel waiting guidance and control system shows the location of the entire substrate 20 including the elongate element 22 and the small discrete elements 24 forming a waiting line to one or more automated teller machines 26. However, it should be understood that the use of the personnel guidance and control system in connection with the automated teller system designated as “ATM” is only for purposes of illustrating the principles of the invention and that the invention is operable with countless other activities.

The elongate element 22 may have imprinted on its upper surface, or otherwise applied to the upper surface, certain indicia 28 thereon for providing instructions to the group of individuals. As a simple example, the indicia 28 on the elongate element 22 may read “Wait Here” or “Next”, or other similar words which define a location in which individuals at the head of a line are requested to wait. Thus, in the case of an automated teller machine, the individual at the head of the line will wait their turn to use the automated teller machine until completion of use by a party presently at the automated teller machine.

The holding of a line of individuals at a pre-selected distance away from the automated teller machine will also allow any security camera associated with that teller system to properly scan the line of individuals waiting to use the machine. Thus, if a security problem should arise and which can be observed by the camera system or if there is another problem in the line of individuals, that is scanned by the camera system, a potential intervening action may be taken. Thus, the control system of the invention provides an added degree of security.

In the embodiment of the invention as illustrated, the elongate element 22 has somewhat of an inverted dish-shaped construction and is formed on its underside with an angular downwardly facing rim 30 and a recessed bottom wall 32. This construction renders a light weight elongate element 22 without materially affecting its structural properties. Moreover, the recessed bottom wall also, in certain embodiments, allows for a convenient stacking and nesting of the elongate elements for purposes of shipping and storage.

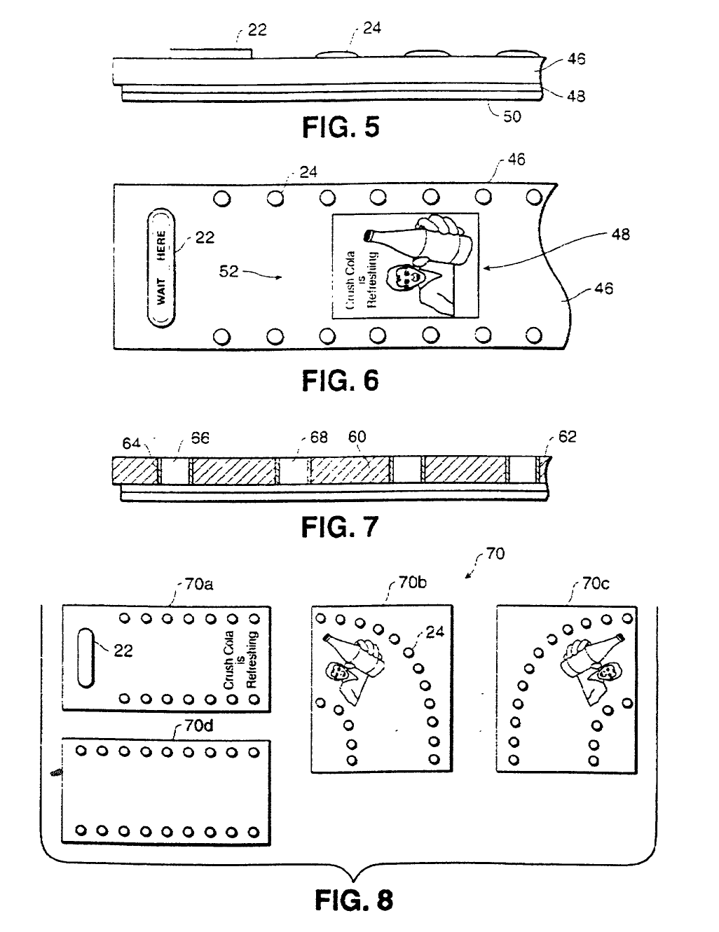

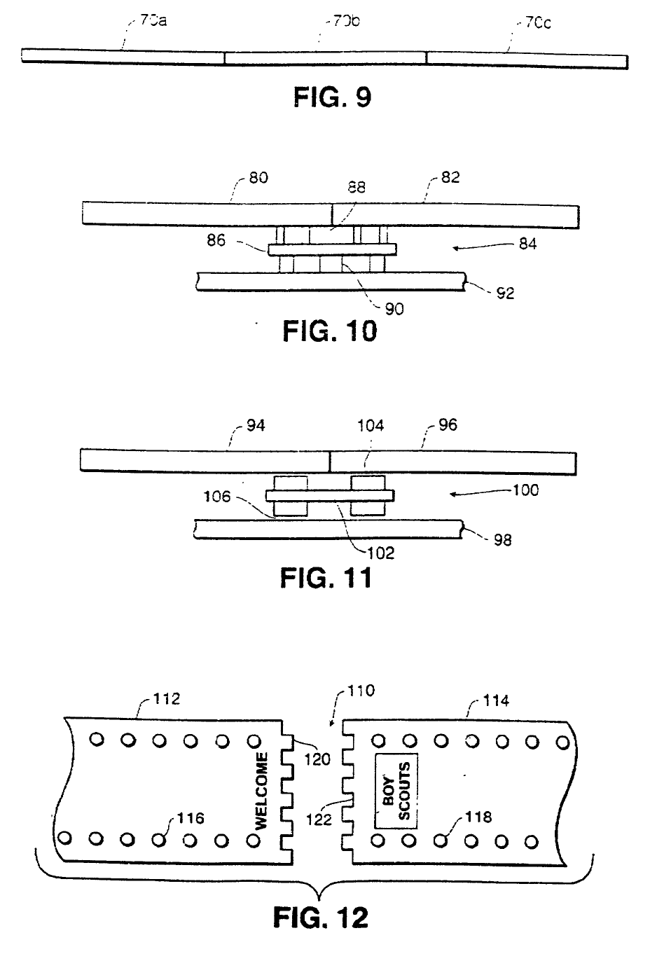

FIG. 2 further illustrates the elongate element 22 mounted within an substrate such as the substrate 20. In this particular case, the substrate is illustrated as being formed of carpeting material. However, and as indicated, any material form can be used for this purpose.

The small discrete elements 24 forming part of the personnel guidance and control system of the invention are circular in shape, as shown in the top plan view thereof. Moreover, each of the small discrete elements 24 have recessed bottom walls, such that they form an annular downward facing rim 34 and a recessed bottom 36, all in the manner as best illustrated in FIG. 6 of the drawings. The lower edges of each of the discrete elements 24 are adapted for engagement with the ground cover substrate 20 and are located at an angle such that the sole or heel of a shoe will not catch on that lower edge and these edges will also allow wheelchairs to easily roll over the discrete elements.

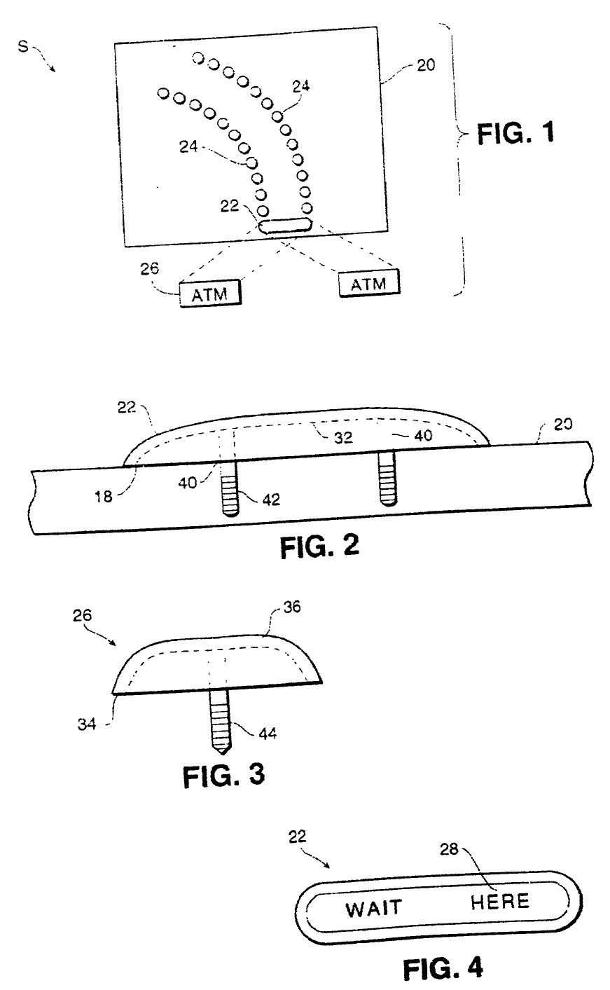

In accordance with the present invention, and particularly by reference to FIG. 1, it can be seen that the elongate element 22 and the small discrete elements 24 can be located on a ground cover substrate in a desired arrangement in order to achieve a guidance path and a head of a line position for a group of individuals. One of the important aspects of the present invention is that this personnel guidance and control system is not readily subjected to damage or theft and can be relatively fixedly secured to a ground surface, but yet removable from location in another location.

In one embodiment of the present invention, the elongate element 22 is provided with a plurality (a pair as shown) of spaced apart screws 40 which may be inserted into a ground cover substrate, such as a carpeted ground cover substrate. Moreover, these screws 40 allow for fastening fitting within a carpet for retentive securement thereto. In this case, the screws have a fairly coarse thread 42 thereon such that the threads only allow a minimal number of turns of the screw. In this way, where the screws are used for securing the elongate element 22 to a carpetlike fabric material, they will not tear the material and only engage the pile of the carpet or rug.

It is also possible to secure the small discrete elements to a ground cover substrate, as for example, by means of an adhesive securement or otherwise by means of screws, such as the screws 44.

FIG. 3 more fully illustrates a single screw 44 molded into each of the small discrete path defining members 24. Again, this screw 44 has a large diameter thread which is relatively coarse and only permits a limited number of turns, much in the same manner as the screws 40, in the elongate element 22.

The small discrete path defining elements 24 may have an adhesive strip 46 on the downwardly presented rim thereof. Moreover, the adhesive strip 46 may be covered with a releasable and removable protective backing, if desired. In accordance with this construction, the removable backing strip can be removed for allowing the adhesive strip to become secured to a ground cover substrate.

It should be understood that the elongate element 22 could also be provided with adhesive strips on its downwardly facing rim 30. Thus, and in this way, the elongate element can be secured to a ground cover substrate much in the same manner as the small discrete elements.

As indicated previously, the present invention utilizes a ground cover substrate which is disposed on a ground surface. The ground surface may be any form, such as a ground soil surface, or otherwise it may be a manufactured surface, such as a wooden surface, a vinyl tile or ceramic tile surface or, for that matter, a wood surface. With hard covered surfaces, the ground cover substrate is frequently provided with an adhesive means and preferably a releasable adhesive means so that the ground cover substrate can be removed from the ground surface. In the case of a carpeted or rug surface, the ground cover substrate may be secured through improved carpet strips in manner as hereinafter described.

In the present invention, each of the elongate elements 22 and the small discrete elements 24 can be pre-mounted on a ground cover substrate, as aforesaid. In this way, it is only necessary to apply the ground cover substrate to a ground surface.

FIG. 5 shows an embodiment of the invention in which there is an elongate element 22, such as a head of a line element, and a plurality of discrete path-defining elements 24 starting from opposite sides of the elongate element defining a path, much in the manner as shown in FIG. 1 and, for that matter, in FIG. 6. The ground cover substrate in this embodiment may adopt the form of either a relatively rigid material, such as a vinyl tile material or the like, or it may adopt the form of a fabric material, such as a carpet. FIG. 5 illustrates a ground cover material 46, such as a relatively rigid type material, e.g. a vinyl ground covering material, having an adhesive surface 48 on its underside. The adhesive is covered by a releasable backing 50, such that when the backing 50 is removed, the adhesive 48 can be secured to a ground surface as, for example, another manufactured and rigid surface. The term “ground surface” is used herein to reflect any surface to which the substrate is applied and does not necessarily imply a ground soil surface.

FIG. 6 illustrates an embodiment of the invention in which there is a ground cover substrate 46 having the elongate head of the line element 22 and the individual discrete path-defining elements 24. In this particular case, the path-defining elements are located at each of the sides of the ground cover substrate 46 to form an individual pathway 48. However, it should be understood that the individual discrete elements could be located in a different arrangement, such as to form an arcuate path or the like.

In the embodiments of the invention as shown in FIGS. 5 and 6, the elongate element 22 and the individual discrete elements 24 may be integrally formed in the ground cover substrate 46 in any of a variety of fashions. As indicated previously, the elongate element 22 and the discrete path-forming elements 24 may be woven into a carpet ground cover substrate. Otherwise, if the ground cover substrate is relatively hard material, such as a vinyl, they can be pre-printed onto the vinyl. Further, they can be painted onto the ground cover substrate, or otherwise applied. In all cases, the individual ground cover substrates 46 can then be taken to a site of use and readily and easily applied to the ground surface as, for example, through an adhesive layer 48 in connection with the embodiment of FIG. 5. In like manner, screws may also be provided on the underside of the ground cover substrate 46 for securement to a relatively rigid ground cover surface. Other means for releasably securing the ground cover substrates to the ground surface may be used. In addition, these various segments may merely be laid upon the ground surface.

Further, in the embodiment as shown in FIG. 6, there is an informational presentation 52, which in this case is a type of advertising or promotional material. The exact form in which this informational presentation is made in the substrate 46 is hereinafter described in more detail. However, the entire message presentation is set forth in one substrate.

FIG. 7 illustrates an embodiment of the invention in which there is a carpet material ground cover substrate 60. The carpet substrate 60 is provided with a plurality of openings 62 for the individual discrete elements and an enlarged opening 64 for the elongate element 22. In this particular case, a plug 66 having the size of an elongate element, but of a different color than the carpet 60, is inserted in the enlarged opening 64. In each of the other openings 62 there are provided plugs 68 representing the small discrete path-defining elements. These plugs 68 would also have a different colored surface than the carpet substrate 60. In addition, each of the individual plugs 66 and 68 can be provided with a slightly raised surface, as shown in FIG. 7, if desired.

In another embodiment of the invention, modular ground cover substrates 70 could be provided, as shown in FIG. 8. There is a first substrate 70a which has an elongate element 22 formed on the surface thereof or incorporated in the material thereof. A second carpet substrate 70b has a plurality of small discrete elements 24 located in somewhat of an arcuate path and thereafter leading into a straight or linear path. In this way, by combining the substrates 70a and 70b, one could form the start of a personnel guidance path which then has an arcuate turn in approximately a 90° direction. By adding a further substrate 70c, which also provides an arcuate turn in an opposite direction, one could further revise the guidance path. By adding a further substrate 70d, which also has elongate columns of small discrete elements, a linear path-defining portion would be added to the arcuate path of the substrate 70b.

These various substrates 70a through 70d all show various modular ground cover substrates which can be used in the invention and show a limited number of various discrete path-defining element arrangements. It should be understood, however, that these various substrates 70a through 70d are only illustrative of the numerous embodiments of the invention would could be obtained. Thus, rectangularly shaped corner portions could be provided and arcuate corner portions with very small or very large angles could also be provided. In addition, various other designs could be provided on a substrate for insertion between two other substrates defining a pathway to add some variation in design to the pathway.

In the embodiment of the invention as shown in FIG. 8, a portion of an informational message is set forth in the first ground covering substrate 70a, and a remaining portion of that message is set forth in the ground covering substrate 70b. In this way, when the two substrates are abutted or otherwise connected together, they will form a complete informational message. Thus, and in the embodiment as shown, a word message can be set forth in one substrate and a pictorial message can be set forth in another abutting or adjacent substrate.

In accordance with the present invention, a user can obtain a plurality of individual modular substrates and arrange these substrates in a pattern which suits the particular user. Thus, for example, the user could abut three ground cover substrates, such as, for example, the ground cover substrates 70a, 70b and 70c together in a manner as shown in FIG. 9. These ground cover substrates could be merely laid upon a ground surface or otherwise secured to the ground surface.

In the case where the ground cover substrates are formed of a carpeted material, the ground cover substrates, such as substrates 80 and 82, may be secured to another carpeted ground surface by means of specially designed carpet strips 84, as shown in FIG. 10. Each carpet strip 84 comprises a small flat metal substrate 86 which has nails or similar pointed prongs 88 on the upper surface for insertion into the carpet substrates 80 and 82 and nails 90 on the undersurface for insertion into the carpeted ground surface 92. In this way, the strips 84 hold the two ground cover substrates 80 and 82 in an abutted position on a carpeted ground surface 92.

FIG. 11 illustrates an embodiment where two relatively rigid ground cover substrates 94 and 96 are abutted against one another to form a desired pattern on the upper surface. These two ground cover substrates 94 and 96 are, in turn, secured to a relatively rigid ground cover, such as a ceramic tile surface 98, by means of fastener strips 100. In this case, the fastener strips 100 also may have a metal substrate or other hard substrate 102, along with adhesive surfaces 104 on the upper portion thereof and adhesive surfaces 106 for securement to the ground surface 98.

It should be understood that the fastener mechanisms for securing the various ground cover substrates to the ground surface are only illustrative of a large number of mechanisms which could be employed for this purpose. Thus, fiber fastening strips and the like could be used.

It should be recognized that indicia could be incorporated on the small discrete path-forming elements, such as the elongate element. For example, arrows could be formed on one or more of the small discrete path-defining elements. In this way, the arrows or other indicia literally co-act with the small discrete elements in defining a path. It should also be understood that the discrete path-defining elements could have other shapes, as opposed to a circular shape as shown. Thus, the small discrete path-defining elements 24 may have the shape of an arrow. In addition, the small discrete path-defining elements and the elongate head of the line element may all have light emitting diodes for lighting the path which is formed. Moreover, these diodes could remain in a permanently lit condition or they could be energized sequentially, as hereinafter described.

It is also possible to provide interlocking means for releasably connecting each of the substrate sections together in a desired guide forming path. FIG. 12 illustrates one such interlocking arrangement 110 on a pair of linearly located substrate sections 112 and 114, which each have small discrete guide path forming elements 116 and 118 on their upper surfaces. In this particular case it can be observed that the interlocking arrangement 110 comprises teeth 120 on one of the substrate sections and mating interlocking teeth 122 on the other of the substrate sections 114.

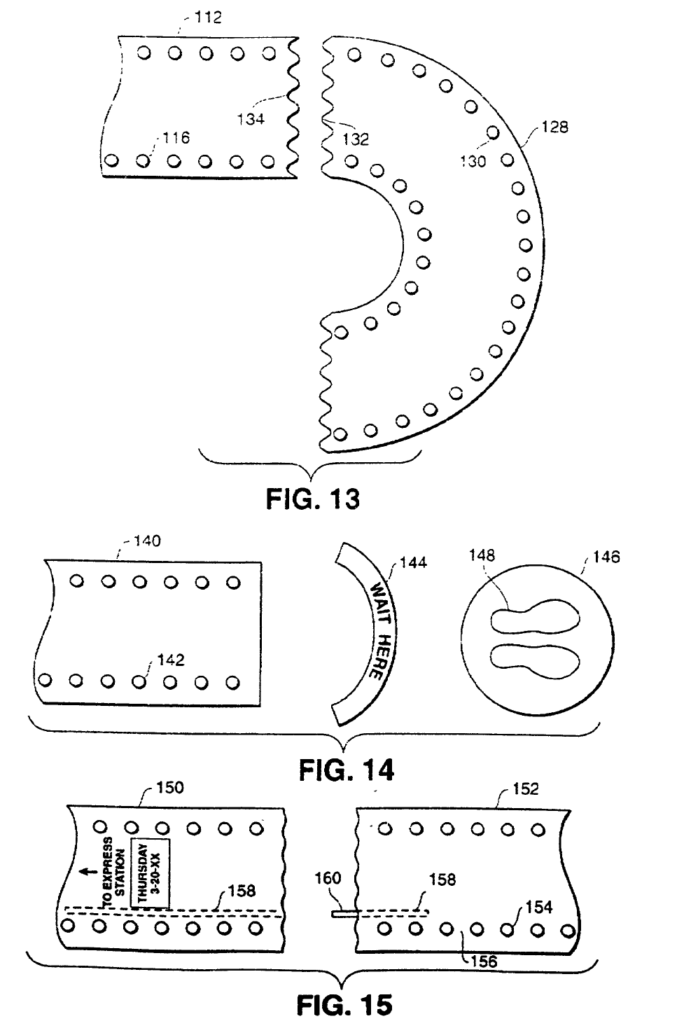

It is also possible to provide substrate sections which are not necessarily linear, as shown in FIG. 13. For example, FIG. 13 shows a substrate section 112, similar to that previously described, and an arcuately shaped substrate section 128, also having small discrete path forming elements 130 on its upper surface. Other shapes of substrate sections could also be employed, such as the U-shaped substrate section 128 illustrated in FIG. 15, and which also has the small discrete path forming elements 130 on its upper surface.

In the embodiment of the invention as shown in FIG. 13, there is also a modified form of interconnecting means which includes a somewhat serrated edge 132 on the arcuate substrate section 124 and a mating and corresponding serrated edge 134 on the generally linear substrate section 112. It should be understood that any form of interlocking means could be used.

It is not always necessary to actually physically abut the individual substrate sections forming a guide path or to interlock same. For example, the individual pieces forming a guide path could also be used in a spaced apart relationship with sizes, shapes and locations which identify a particular guide path. For example, with a group of individuals who are to be processed as, for example, by having photographs taken, a linear substrate section 140 may be provided with the discrete path forming elements 142 on each of the opposite edges thereof. This linear section 140 thereby defines a particular guide path for a group of individuals.

In place of having a head of line position, an individual arcuate section 144 is spaced from the right-hand end of the linear substrate section 140, as shown in FIG. 14. This arcuate section could represent, for example, a next in line position to reach a destination 146. The arcuate section could be replaced by an arrow or the like, as well. The destination 146 is the activity reached by the party at the very head of the line to have the activity occur. Thus, for motor vehicle registration, where photographs are employed, the destination 146 may be a specified area of substrate section and may even have an imprint of shoes 148 on its upper surface to identify a location where that individual would stand during the taking of a photograph.

FIG. 15 illustrates an embodiment of the invention utilizing a pair of substrate sections 150 and 152 which, in this particular embodiment, are as linear substrate sections. However, they may be arcuate substrate sections, U-shaped sections, or any other shape of substrate section. Furthermore, and in this embodiment, the individual path forming elements are rows of light emitting diodes 154 and 156 adjacent the longitudinal edges thereof. In this respect, the light emitting diodes function as the small discrete path forming elements previously described.

In order to provide electrical current to these light emitting diodes, and particularly where the substrate sections 150 and 152 are carpet sections, electrical conductors 158 can be extended through the individual carpet sections, as shown. These electrical conductors would be connected to the individual light emitting diodes by branches (not shown). Moreover, in order to connect the abutting or interlocking ends of each of the substrate sections 150 and 152, one of the substrate sections is provided with an outwardly struck tab or prong 160 adapted to fit within a socket 162 formed in a conductor 158, in the manner as best shown in FIG. 17. It should be understood that any other type of electrical light pattern could also be employed using the electrical conductors as shown in the substrate sections of FIG. 15.

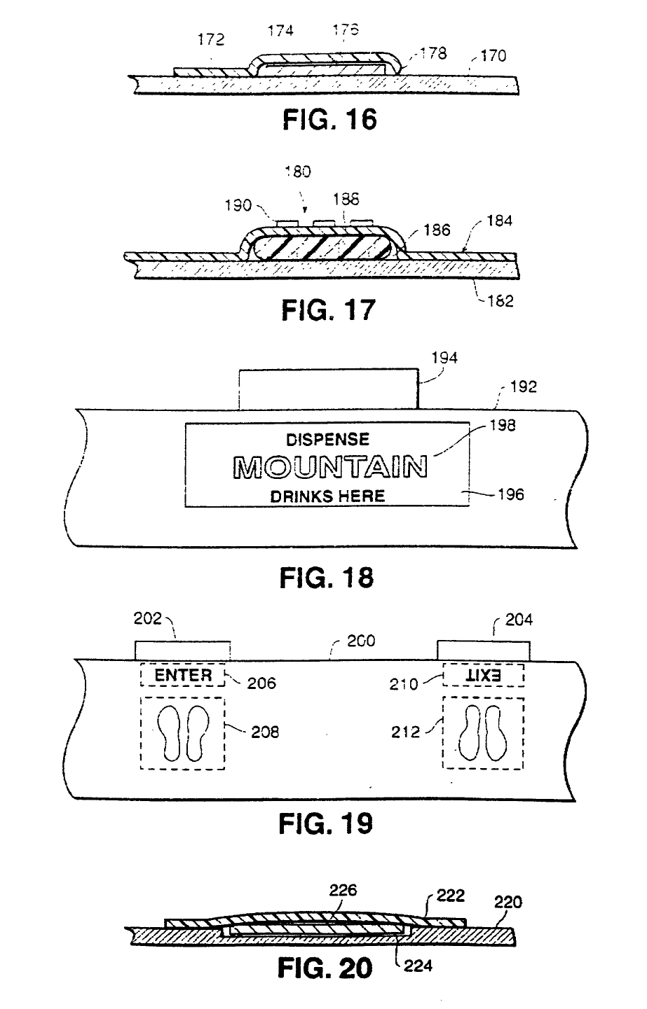

FIGS. 16 through 20 illustrate various embodiments of the invention more fully directed to the informational display sections incorporated in the various substrate section forming part of the invention. As indicated previously, it is possible to use a single stationary substrate which does not necessarily form a guide path, but rather identifies a particular control location for which a user may stand in order to accomplish a particular activity. Thus, for example, a certain location may be identified for purposes of taking a picture, dispensing a beverage, operating an ATM unit, etc. Nevertheless, it is important in connection with the present invention to provide an informational display which will attract the attention of the user, whether or not that informational display is for pure information purposes or otherwise advertising and promotional purposes.

FIG. 16 illustrates a substrate 170 with a transparent plastic cover piece 172 fixedly secured to an upper surface thereof, and forming a pocket 174 for receiving an informational material substrate 176. The pocket-forming cover piece 172 is also provided with an open end covered by a flap 178, thereby allowing separation of the flap 178 from the substrate 170 in order to obtain access to the pocket 174. In this way, the informational bearing substrate 176 can be removed and a new sheet inserted in its place.

FIG. 17 illustrates a modified form of display presentation section 180 on a ground covering substrate section 182. This display section 180 includes an outer cover strip 184 forming a pocket 186 between the under surface of the cover strip 184, and the substrate section 182. A sponge foam like material plug 188 is located in the pocket 186, and provides somewhat of a pillow-type effect the display section 180. Thus, this display section 180 is raised relative to the remaining portion of the ground covering substrate 182.

Imprinted on the upper surface of the display section 180 in the region above the sponge foam core 188 is printed information material 190. Moreover, this information bearing material 190 may be embossed on the upper surface, and raised slightly with respect to the upper surface to thereby enhance the appearance of the message. In this particular case, the cover sheet 184 can be removed and replaced without necessarily requiring complete removal of the entire substrate section 182.

FIG. 18 illustrates an embodiment in which there is a substrate section 192, located at a dispenser 194, such as a dispenser of soft drinks. In this case, mounted within a recess formed in the substrate section 192, is an information bearing substrate 196, which may contain a message 198 on the upper surface thereof. In this particular case, the substrate section can say “Dispense Mountain Cola Here” on one day, and on another day, the “Mountain” portion could be removed, and another brand name producer of a cola could be inserted in its place. Otherwise, the entire information bearing section 196 can be removed. In this way, there is a convenient interchangeability of advertising or promotional material allowing numerous producers of products and services to offer their services to individuals standing at a particular activity or waiting to reach a particular activity.

FIG. 19 illustrates an embodiment of an invention in which there is a single floor mat 200 in front of an entrance door 202, and an exit door 204 leading into, e.g., a hotel lobby or the like. If it is desired to change the entrance and exit arrangements, an entrance sign 206 along with a illustration of a pair of feet 208 can be removed from the mat 200. The same holds true with an exit sign 210 and a pair of feet 212, pointed in the opposite direction showing an exit from this hotel or lobby or other location. Thus, merely by removing the individual sections, it is possible to change the directions of exit and entry, or otherwise, it is possible to put signs “No Admission”, etc.

FIG. 20 further illustrates an embodiment of the invention, in which there is a floor covering substrate section 220 covered by a transparent cover piece 222. The ground cover substrate section 220 is provided with a depression forming a recess 224 to receive an information bearing sheet 226, and which has information on its upper surface. The cover sheet 222 is removable as, for example, by means of fiber fastening attachment strips, and re-securable to the upper surface of the substrate section 220, thereby allowing interchangeability of information sheets 226.

It should also be recognized that it is possible to use a flat screen display. For example, returning to FIG. 20, the information bearing sheet 226 could easily be replaced by a plasma-operated screen. In this particular case, the cover section 222 would be formed of a rigid material so that one walking on the substrate section 220 would not damage the flat panel display screen 226.

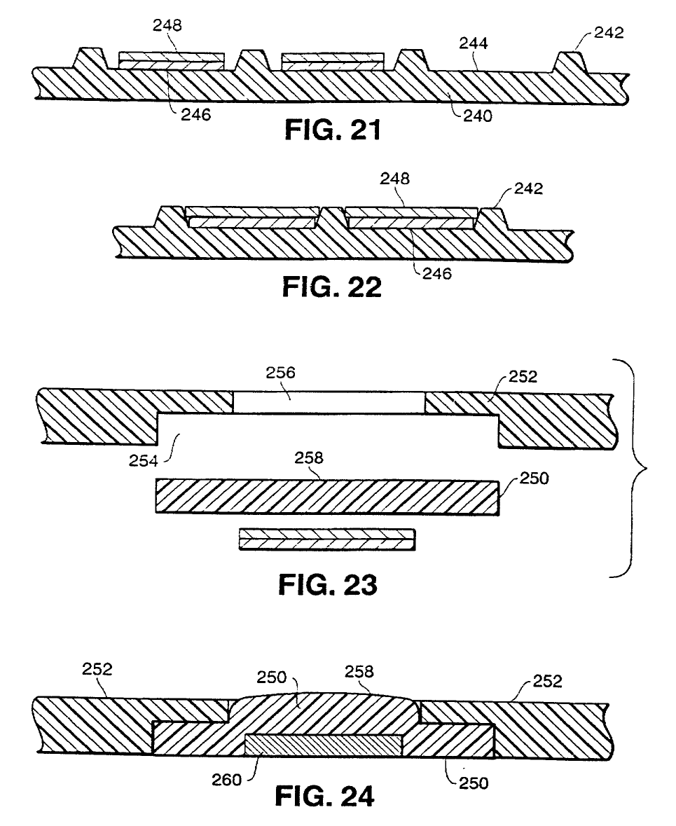

FIG. 21 illustrates an embodiment of the invention in which there is a ground covering substrate 240, typically in the form of a rubber or vinyl plastic material, and having a plurality of upstanding ribs 242 on its upper surface. In order to present an informational display, recesses 244 formed between each of the ribs are sized to receive an adhesive strip 246 and which is provided with an adhesive, both on its lower surface and on its upper surface, so as to be able to stick to the substrate 240 and to hold an informational message bearing section 248. Thus, by using the adhesive strip 246 with an adhesive coating on each of the opposite surfaces, it is possible to remove the informational bearing message 248 and substitute another informational bearing message therefor.

FIG. 22 discloses an arrangement similar to FIG. 21, except that in this particular case, the adhesive 246 extends for the full dimension between each of the ribs 242, whereas in the original embodiment of FIG. 21, the adhesive strips 246 extended only a portion of the distance between the ribs 242. In like manner, in connection with the embodiment of FIG. 22, the informational bearing section 248 also extends the full distance between each of the ribs. Moreover, the informational bearing section 248 can be flush with the upper surface of the ribs, or it can be below the surface of the upper edge of the ribs 242.

The embodiment of FIGS. 21 and 22 is highly effective where the informational bearing materials may also be in the form of the small discrete elements. In this way, it is possible to change either the discrete elements or the informational bearing message. Typically, for arrows and like directional markers, this type of arrangement has proved to be highly effective.

FIG. 23 illustrates an embodiment of the invention in which larger informational bearing substrates 250 can be used. A ground covering substrate 252 is provided and is formed with a recess 254 on its underside having an upper opening 256. The informational message bearing section 250 has a message 258 on its upper surface. It can be seen by reference to FIG. 23 that this section 250 fits within the recess 254. Moreover, the message 258 is exposed for viewing through the viewing opening 256 formed in the substrate 252. In order to provide a raised effect to the message 258, an insert piece 260 is also provided and forces the upper surface of the information bearing section 250 upwardly so that the message 258 actually lies above the upper surface of the ground covering substrate 252. Moreover, the bottom surface of the insert piece 260 will thereupon lie flush with the underside of the information bearing section 250.

It should be understood that the various means for removably mounting informational bearing messages on a ground covering substrate is only illustrative in connection with the present invention. Numerous other means for accomplishing this end could also be provided in accordance with and embodied by the present invention.

It is also possible to use enhancements to the small discrete elements. Thus, in order to enhance a promotional add for a soft drink, one could use bottle cap designs as the small discrete elements. In like manner, in order to enhance an advertisement of, e.g. cookies, the small discrete elements could be designed as a cookie.

Thus, there has been illustrated and described a unique and novel personnel location control system which meets and fulfills all of the objects and advantages which have been sought. It should be understood that many changes, modifications, variations and other uses and applications will be become apparent to those skilled in the art after considering this specification and the accompanying drawings. Therefore, any and all such changes, modifications, variations and other uses and applications which do not depart the spirit and scope of the invention are deemed to be covered by the invention.

Having thus described the invention, what I desire to claim and secure by Letters Patent is:

1. A personnel guidance and location control system for guiding a group of pedestrian individuals into a line thereof and controlling movement thereof, said guidance and location control system comprising:
a) a ground cover substrate for disposition on a ground surface;
b) at least one elongate element associated with said cover substrate and in a fixed location thereon for defining an end of a line of the group of pedestrian individuals and representing a waiting location for the individual at the front end of the line, so that the individuals may proceed to a destination in advance of the front end of the line in an orderly and successive manner;
c) a plurality of small discrete elements associated with said cover substrate in fixed locations thereon relative to the elongate element and extending from the elongate element to define a pathway of movement for the group of individuals; and
d) means associated with said elongate element and said small discrete elements for securing same with the cover substrate, whereby the ground cover substrate and elongate element and small discrete elements can be secured to the ground surface presenting a desired pattern to enable the orderly and controlled movement of a group of pedestrian individuals into one or more lines of same to a destination.

2. The personnel guidance and location control system of claim 1 further characterized in that said small discrete elements extend from regions in proximity to opposite ends of the elongate element.

3. The personnel guidance and location control system of claim 1 further characterized in that indicia is provided on the upper surface of the elongate element.

4. The personnel guidance and location control system of claim 1 further characterized in that fastening means associated with the underside of the elongate element and with the underside of the small discrete elements and comprises a downwardly projecting threaded member.

5. The personnel guidance and location control system of claim 1 further characterized in that fastening means associated with the underside of the elongate element and the small discrete elements and is an adhesive strip.

6. A system for controlling movement of pedestrian personnel and presenting informational messages in connection therewith, said system comprising:
a) a ground cover substrate for disposition on a ground surface;
b) at least one element associated with said ground cover substrate for representing a standing or waiting position for a pedestrian individual and in which an activity may take place; and
c) first informational message located on said substrate in such manner that it is relatively interchangeable at will so that a second informational substrate may be readily and quickly interchanged on said substrate for said first informational message.

7. The system of claim 6 further characterized in that said first information message is located under a relatively transparent cover member secured to said substrate with a pocket allowing access to said first informational message for removing same and inserting same.

8. The system of claim 6 further characterized in that said informational message has a raised portion which extends above the surface of said substrate.

9. The system of claim 6 further characterized in that said informational message shows direction of movement of one or more pedestrian individuals.

10. The system of claim 6 further characterized in that said informational message identifies a particular standing location for an individual in which an activity is to be conducted.

11. The system of claim 6 further characterized in that a foam portion is located with respect to said substrate in order to provide a raised effect to the informational message.

12. The system of claim 6 further characterized in that said informational message is mounted within a recessed portion in said substrate and is removable therefrom.

13. A method for a personnel location and control system for guiding a group of individuals and also presenting informational message to said pedestrian individuals, said method comprising:
a) a ground cover substrate for disposition on a ground surface;
b) a group elements associated with said ground cover substrate to define a pathway for guiding the movement of the pedestrian individuals; and
c) means for presenting a message on an upper surface of said substrate in such manner that the message is removable therefrom and replaceable by another message.

14. The system of claim 13 further characterized in that there is a plurality of small discrete elements defining a pathway of movement for the pedestrian individuals and an elongate element defining an end of the line position for a person at the head of the line of pedestrian individuals.

15. The system of claim 13 further characterized in that said first information message is located under a relatively transparent cover member secured to said substrate with a pocket allowing access to said first informational message for removing same and inserting same.

16. The system of claim 13 further characterized in that said informational message has a raised portion which extends above the surface of said substrate.

17. The system of claim 13 further characterized in that said informational message shows direction of movement of one or more pedestrian individuals.

18. The system of claim 13 further characterized in that said informational message identifies a particular standing location for an individual in which an activity is to be conducted.

19. A method of controlling the locational movement of one or more pedestrian individuals and simultaneously providing an informational message to said one or more pedestrian individuals, said method comprising:
a) providing a substrate to a ground surface and having an upper surface thereon for walking disposition by said one or more pedestrian individuals;
b) providing one or more elements on said upper surface of said substrate to represent a location for said one or more pedestrian individuals in which a particular activity may occur;
c) locating an informational message on said substrate in a position where the same is readily visible to and viewable by the one or more pedestrian individuals; and
d) changing that informational message and substituting another informational message therefor.
